(19) United States
(12) Patent Application Publication
(10) Pub. No.: US 2005/0225967 A1
(43) Pub. Date: Oct. 13, 2005

(54) Projection system

(76) Inventor: Petrus Hendrikus Antonis, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/514,282

(22) PCT Filed: May 16, 2003
(86) PCT No.: PCT/IB03/01990

§ 371 Date: Nov. 12, 2004

(30) Foreign Application Priority Data
May 17, 2002 (EP) 020769345

(51) Int. Cl. F21L 2/00

(52) U.S. Cl. 362/157

(57) ABSTRACT

The invention relates to a projection system and a driver for use in such a system. According to the invention it comprises a high pressure discharge projection lamp having a discharge tube enclosing a discharge space and a first and second main electrode, which system also comprises means to operate the projection lamp with an AC lamp current having a frequency of at least 3 MHz.

The invention relates to a projection system comprising a high pressure discharge projection lamp having a discharge tube enclosing a discharge space and a first and second main electrode, which projection system also comprises a ballast circuit to operate the high pressure discharge projection lamp with an AC lamp current.

The invention also relates to a combination of a high pressure discharge projection lamp and a ballast circuit and to a ballast circuit.

The high pressure discharge projection lamps used in a projection system as mentioned in the opening paragraph are often referred to as U(ltra) H(igh) P(ressure) lamps. In known projection systems comprising a high pressure discharge projection lamp having a discharge tube enclosing a discharge space and a first and second main electrode, flatter is reduced by operating the projection lamp with rectangular current pulses provided with an extra current peak at the end of the rectangular pulses. A circuit suitable for use in such a projection system is known from U.S. Pat. No. 5,608,294. Further developments to arrive at a continuously satisfactory functioning of the projection system during its life time lead to the application of very complex lamp current shapes and consequently to complicated circuit arrangements, for instance such as those disclosed in WO 00/36882 and WO 00/36883. A disadvantage of these known projection systems is that the circuitry that generates the lamp current is comparatively complicated and therefor expensive.

It is an object of the present invention to provide a projection system in which flatter is effectively suppressed during operation while the ballast circuit comprised in the projection system is comparatively simple.

A projection system as mentioned in the opening paragraph is therefor according to the invention characterized in that the lamp current has a frequency of at least 3 MHz.

It has been found that in a projection system according to the invention flatter is effectively suppressed even when the current had a comparatively simple shape (e.g. a sinusoidal shape). As a consequence the ballast circuit can be comparatively simple.

Good results have been obtained for projection systems according to the invention, wherein the high pressure discharge projection lamp has an antenna. Preferably, the antenna is electrically connected with the first main electrode and extends along the discharge tube towards the second main electrode.

It was found more in particular that flatter was effectively suppressed in projection systems according to the invention, wherein the distance between the first and second main electrode is smaller than or equal to 1.2 mm, preferably smaller than or equal to 1 mm.

More in particular, good results in terms of flatter suppression were obtained for projection systems, wherein the lamp current has a frequency in the range of 4 to 8 MHz.

Embodiments of the invention will be explained making reference to a drawing. In the drawing

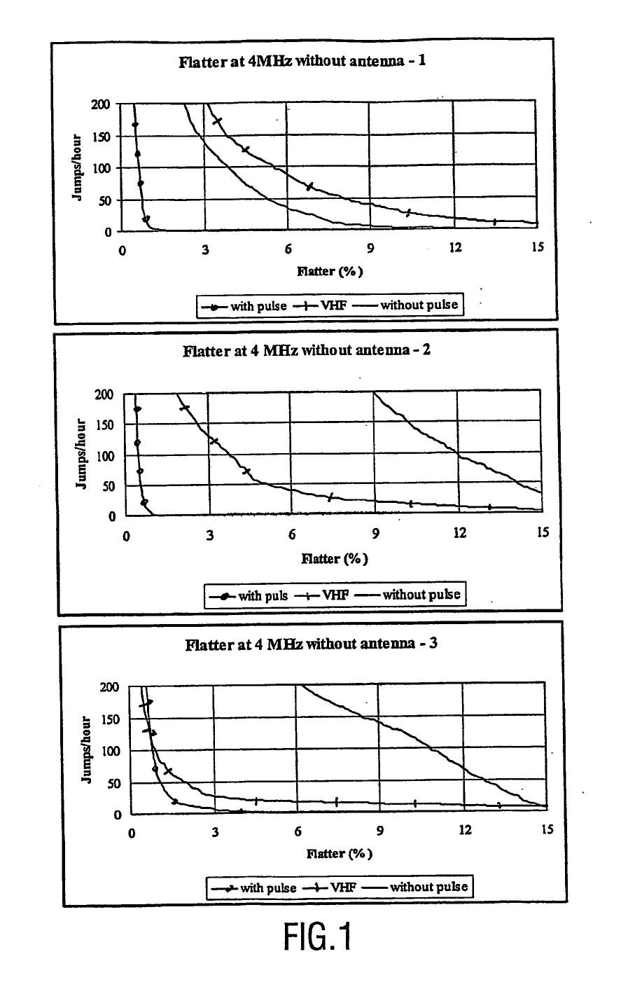

FIG. 1 shows flatter versus jumps/hour for 3 UHP-lamps without an antenna, the ballast circuit operating at 4 MHz current frequency, i.e. 8 MHz power frequency;

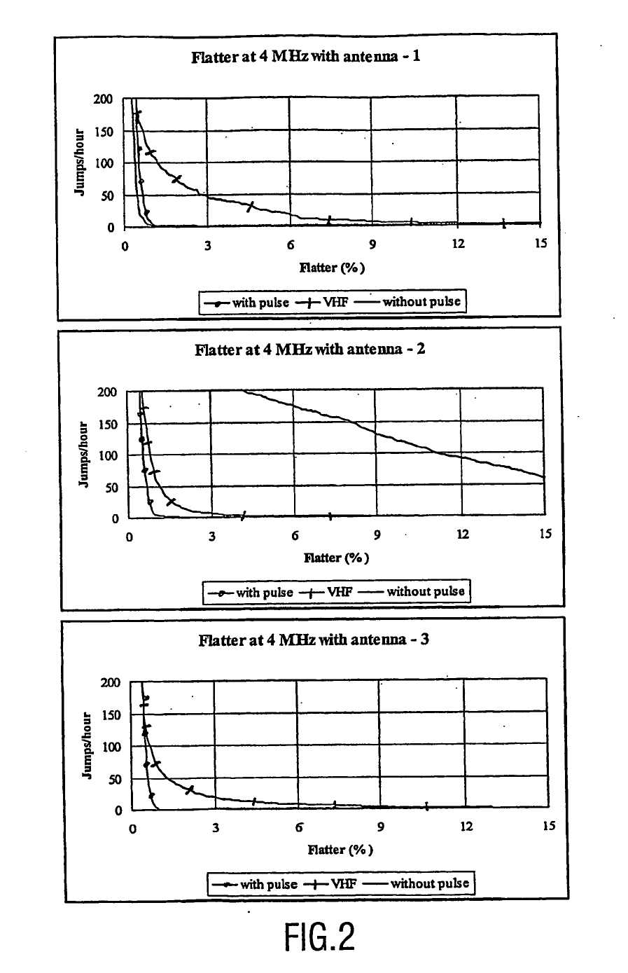

FIG. 2 shows flatter versus jumps/hour for 3 UHP-lamps with an antenna, the ballast circuit operating at 4 MHz current frequency, i.e. 8 MHz power frequency;

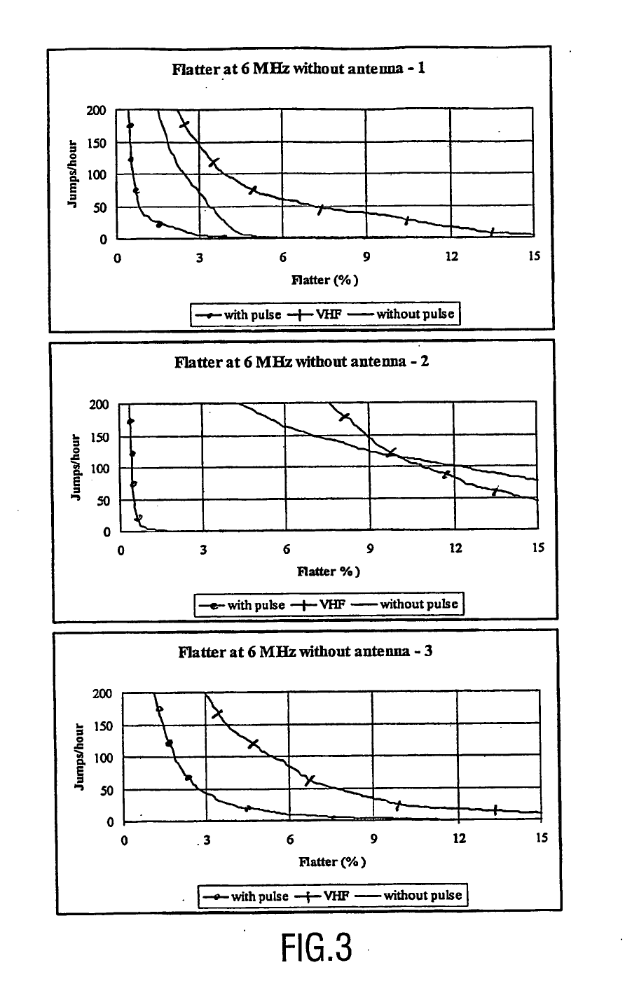

FIG. 3 shows flatter versus jumps/hour for the 3 UHP-lamps without an antenna, the ballast circuit operating at 6 MHz current frequency, i.e. 12 MHz power frequency;

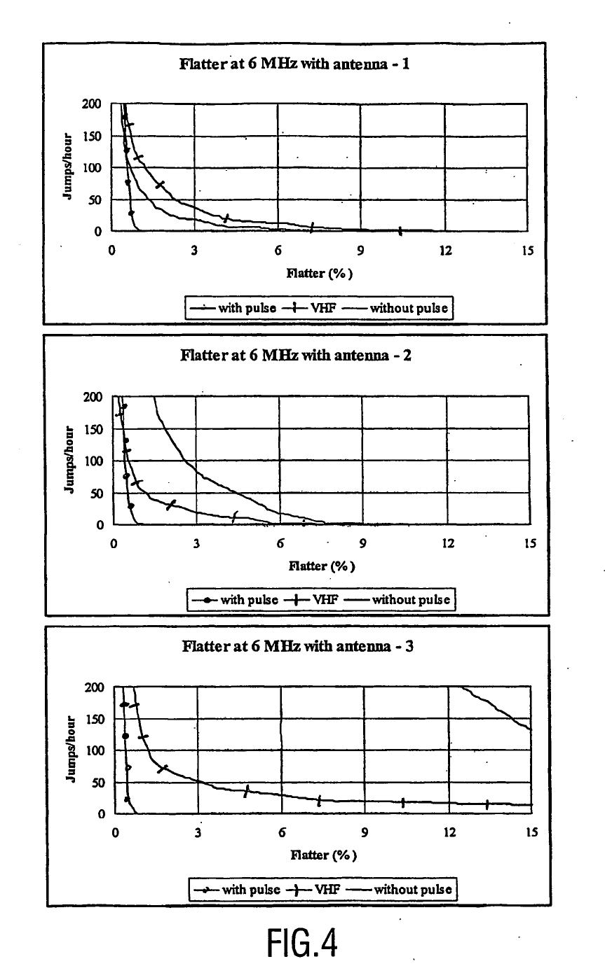

FIG. 4 shows flatter versus jumps/hour for the 3 UHP-lamps with an antenna, the ballast circuit operating at 6 MHz current frequency, i.e. 12 MHz power frequency;

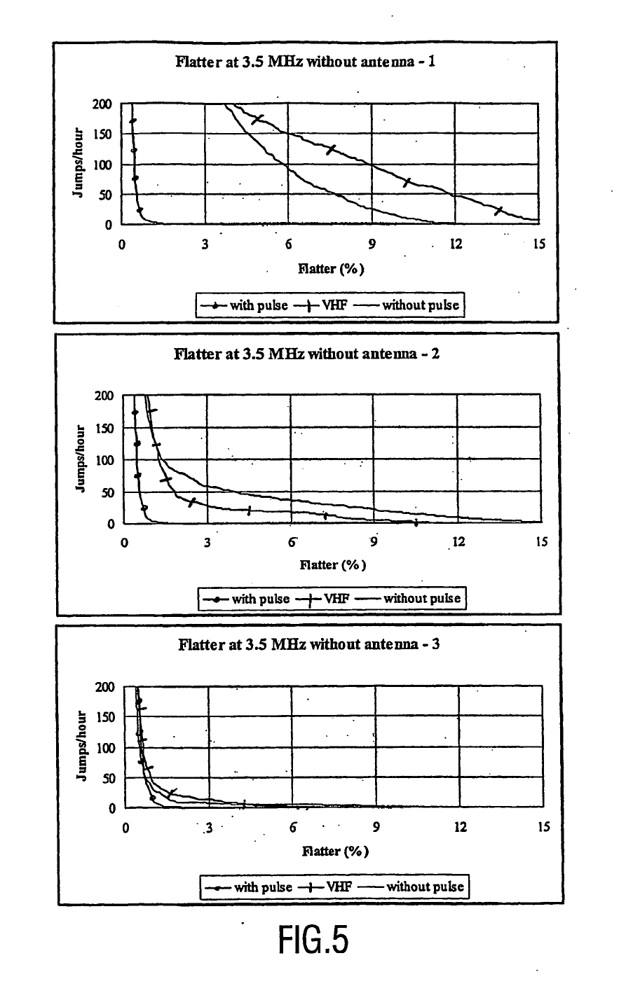

FIG. 5 shows flatter versus jumps/hour for the 3 UHP-lamps without an antenna, the ballast circuit operating at 3.5 MHz current frequency, i.e. 7 MHz power frequency;

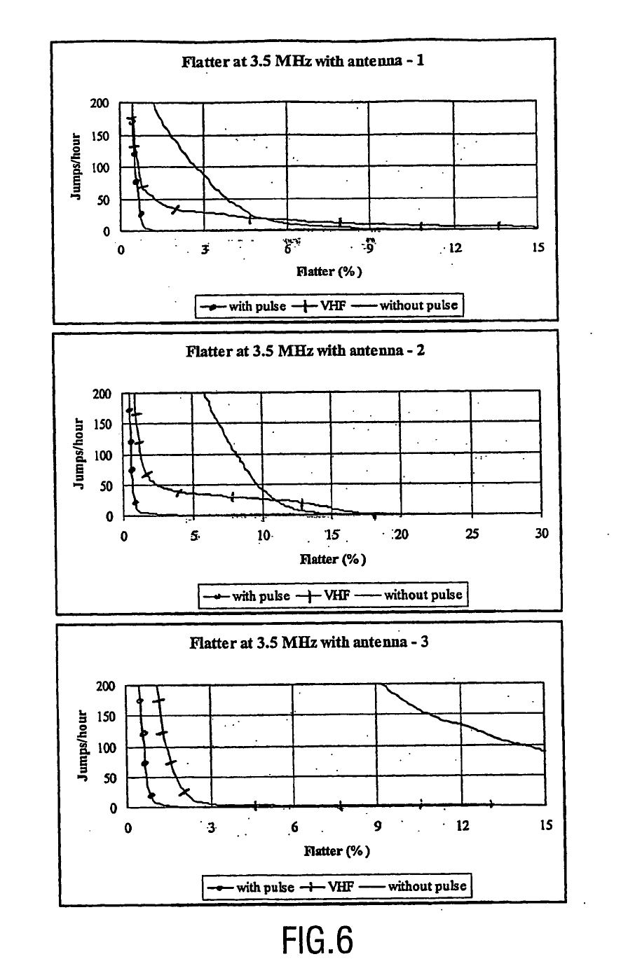

FIG. 6 shows flatter versus jumps/hour for the 3 UHP-lamps with an antenna, the ballast circuit operating at 3.5 MHz current frequency, i.e. 7 MHz power frequency, and

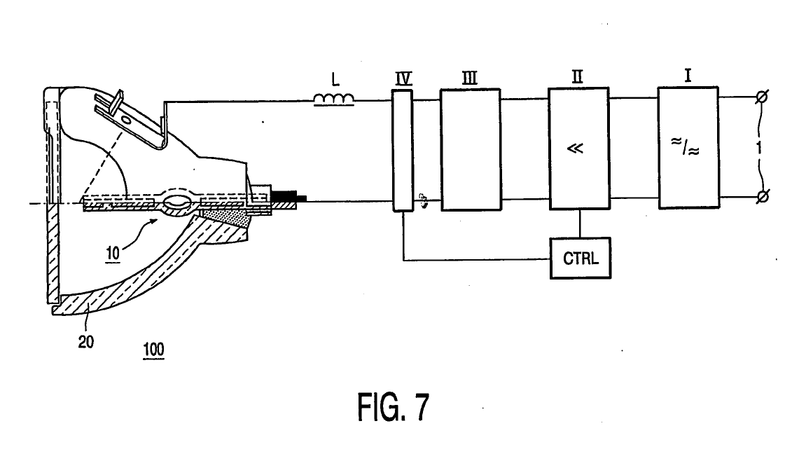

FIG. 7 shows a block diagram of a projection system.

In the experiments of which the results are presented in FIGS. 1-6, a high pressure discharge projection lamp having a discharge tube enclosing a discharge space and a first and second main electrode was operated by means of a ballast circuit supplying an AC current with a frequency higher than 3 MHz to the high pressure discharge projection lamp. Two kinds of experiments are done. The first experiment determines the proportion of flatter in the arc when the high pressure discharge projection lamp is operated with a frequency higher than 3 MHz. The second, rather brief experiment, gives an idea about the color temperature and the performance of the high pressure discharge projection lamp when operated at a frequency higher than 3 MHz.

The first experiment is done making use of flatter equipment measuring the flatter of the arc in a high pressure discharge projection lamp. Flatter is the ratio between the variation in light intensity and the mean light intensity; flatter is given in percent. A high pressure discharge projection lamp is placed in a socket and pointed at a plate with a small aperture. Behind this hole, an optic sensor registers the light intensity. Intensity variations are recorded and the mean intensity can be calculated. The flatter is measured.

The flatter is plotted versus the number of jumps per hour so as to create an unambiguous set of data to evaluate. When the arc jumps, the light intensity through the hole changes.

Six UHP 1.0 mm PAR 23-lamps were tested on a 2.5 hour basis, for 3 different frequencies. Three of the six lamps have an antenna, the other three don't. Every test run compares the flatter results of the VHF-driver (=the ballast circuit supplying a current with a frequency that is higher than 3 MHz to the lamp) to the results of a regular driver known as L-driver, supplying a low frequency square wave shaped current to the lamp without an additional current pulse superimposed on the square wave shape, and to the results of the more recent driver according to U.S. Pat. No. 5,608,294 known as P-driver, also supplying a low frequency square wave shaped current to the lamp with an additional current pulse superimposed on the square wave shape. In order to smooth away possible unknown circumstances some measures are taken:

To count in the differences between the three lamps, the lamps are “transposed” after every test run. Every test is done three times for every frequency. That way, every lamp has been operated by every type of driver.

The same drivers are used in every test run. As a consequence differences between two drivers of the same type cease to count.

The driver with a pulse creates little points on the electrodes and makes the electrodes grow a little closer. To reduce the memory effect of the driver with a pulse, all the lamps are operated for over an hour with the L-driver after the test with the flatter equipment

Preliminary research making use of a ballast circuit generating a 90 Hz square-wave with superimposed VHF-ripple predicted possible stable operation commencing at approximately 6 MHz. The 6 MHz is the power frequency and it corresponds to a 3 MHz current frequency. If the frequency of the VHF-driver is said to be 3 MHz, the current frequency is meant. When the lamps were operated by the VHF driver at a frequency of 3 MHz however, a visual inspection revealed considerable flatter. That's why a safe 4 MHz was chosen to begin the tests with. After the initial tests at 4 MHz, the test was repeated at 6 MHz and again at the smaller value of 3.5 MHz.

In FIG. 1 the flatter for three UHP-lamps without an antenna is plotted versus the number of jumps per hour for three test-runs at a frequency of 4 MHz, i.e. 8 MHz power frequency. In FIG. 2 the flatter is shown for three UHP-lamps equipped with an UV-enhancer and an antenna, also at 4 MHz current frequency.

FIG. 3 gives the flatter for the same lamps as in FIG. 1 but the VHF-operation frequency is now 6 MHz. FIG. 4 gives the flatter for the same lamps as in FIG. 2, VHF-operation frequency 6 MHz.

In FIG. 5 and FIG. 6, again the flatter is plotted versus the number of jumps per hour. The VHF-driver is operated at 3.5 MHz. FIG. 5 contains the data for lamps without an antenna and without an UV-enhancer. FIG. 6 on the other hand shows the data for the 3 lamps with UV-enhancer and antenna.

The contrast between the use of a driver with a pulse (P-driver) and the use of a driver without a pulse (L-driver) is remarkable. In fact the curve of the driver without a pulse is off scale in two cases (FIG. 2 and FIG. 3).

The lamps are also tested with the VHF-driver. VHF-operation is examined to determine whether arc stability is improved, which means that the arc should remain attached to the same place on the electrode because of the higher frequency. The test data does lead to a surprising conclusion that VHF operation is suitable: the Figures indicate that the flatter of the VHF-operated lamps remains in many charts under 3% for the majority of the arc jumps taking place.

The data presented in FIGS. 1 through 6 clearly show that VHF-operation is suitable for use in a projection system. If longer flatter tests would be done, the dissimilarities between the different charts of one figure are expected to disappear.

The VHF signal is preferably substantially sinusoidal, which makes the invention extremely attractive as it makes feasible the use of relatively simple driver circuit arrangements.

In FIG. 7 a schematic diagram is shown of a projection system according to the invention. The system is provided with input terminals 1 to be connected to a power source. I is a generator to generate the VHF signal, which signal is amplified in an amplifier II. III provides an electric matching network between amplifier II and lamp 100. In a detection circuit IV current and voltage are detected, from which the power supplied to the lamp is derived in a control circuit CTRL. The control circuit CTRL generates a control signal for controlling the amplifier so as to operate the lamp at a constant wattage. In an alternative embodiment the control signal controls the generator. Additionally a small self inductance L is provided to stabilize the lamp current. In the projection system used for the described experiments the self inductance L had a value of 14 μH.

In the shown embodiment the lamp has a discharge tube 10 without an antenna, surrounded by a reflector body 20.

In a subsequent experiment the color point and the luminous flux of the UHP-lamps operated on a VHF-driver were measured. Just as before, a comparison is made with the L-driver (without pulse) and the P-driver (with pulse). Four UHP-lamps are tested including two with an antenna and UV-enhancer. The lamps are put in a sphere that measures the characteristics. Table 1 presents the luminous flux of two lamps without an antenna operated on the different drivers. Table 2 presents the color points. Table 3 gives the luminous flux of two lamps with an antenna and UV-enhancer, operated with the different types of drivers and table 4 contains the according color points.

TABLE 1
Luminous flux for UHP-lamp without antenna

| Luminous flux (lm) | | LAMP 1 | LAMP 2 |
|---|---|---|---|
| Driver without pulse | | 7490 | 7390 |
| Driver with pulse | | 7540 | 7550 |
| VHF-Driver | 3.5 MHz | 7360 | 7220 |
| | 4 MHz | 7340 | 7190 |
| | 5 MHz | 7300 | 7130 |
| | 6 MHz | 7150 | 6800 |
| | 8 MHz | 7030 | 6820 |

TABLE 2
Color point for UHP-lamps without antenna

| Color point (x, y) | |
|---|---|
| LAMP 1 | LAMP 2 |

| | | x | y | x | y |
|---|---|---|---|---|---|
| Driver without pulse | | 0.285 | 0.301 | 0.280 | 0.305 |
| Driver with pulse | | 0.283 | 0.302 | 0.280 | 0.306 |
| VHF-Driver | 3.5 MHz | 0.284 | 0.302 | 0.281 | 0.305 |
| | 4 MHz | 0.282 | 0.302 | 0.276 | 0.306 |
| | 5 MHz | 0.283 | 0.302 | 0.279 | 0.306 |
| | 6 MHz | 0.281 | 0.302 | 0.278 | 0.307 |
| | 8 MHz | 0.284 | 0.302 | 0.277 | 0.305 |

TABLE 3
Luminous flux for UHP-lamps with antenna

| Luminous flux (lm) | | LAMP 1 | LAMP 2 |
|---|---|---|---|
| Driver without pulse | | 7520 | 7990 |
| Driver with pulse | | 7790 | 7850 |
| VHF-Driver | 3.5 MHz | 7330 | 7690 |
| | 4 MHz | 7370 | 7680 |
| | 5 MHz | 7330 | 7630 |
| | 6 MHz | 7175 | 7500 |
| | 8 MHz | 7200 | 7400 |

TABLE 4
Color points for UHP-lamps with antenna

| Color point (x, y) | |
|---|---|
| LAMP 1 | LAMP 2 |

| | | x | y | x | y |
|---|---|---|---|---|---|
| Driver without pulse | | 0.284 | 0.301 | 0.282 | 0.299 |
| Driver with pulse | | 0.285 | 0.301 | 0.282 | 0.299 |
| VHF-Driver | 3.5 MHz | 0.283 | 0.300 | 0.283 | 0.300 |
| | 4 MHz | 0.281 | 0.301 | 0.280 | 0.301 |
| | 5 MHz | 0.281 | 0.301 | 0.281 | 0.301 |
| | 6 MHz | 0.280 | 0.301 | 0.279 | 0.301 |
| | 8 MHz | 0.282 | 0.300 | 0.282 | 0.300 |

Four lamps were tested. The results show that the color point of a UHP-lamp operated by means of a VHF driver does not differ much from that of a UHP lamp operated by means of an L-driver or a P-driver. The luminous flux of the lamp seems to decrease with increasing frequency. This trend could lead to the conclusion that the performance of the discharge lamp decreases with increasing operation frequency. However, the power dissipated in the coil (self inductance) has been neglected. The loss in the coil becomes more important at higher frequencies. The setup disregards this loss. That is probably the reason why the luminous flux decreases when the frequency increases.

From the above one is forced to the surprising conclusion that VHF operation of a high pressure lamp of a projection system is an inviting alternative for a system with a low flatter level reduced to an acceptable level with maintaining luminous and color properties at levels comparable to existing systems.

The invention is of particular interest for high pressure discharge lamps comparable to the type known as UHP, make Philips. These lamps have a very small discharge tube volume of several cubic mm.

The lamps used in the experiments were all of the UHP type with a rated power of 120 W, with a quartz discharge tube with internal diameter of 4.3 mm and an external diameter of 9.0 mm. The electrode distance is 1 mm and the filling of the discharge tube comprises Ar with a pressure of about 100 mbar as a buffer gas and Hg. During operation the total pressure in the lamp is 200 bar or even exceeds 200 bar.

1. Projection system comprising a high pressure discharge projection lamp having a discharge tube enclosing a discharge space and a first and second main electrode, which projection system also comprises a ballast circuit to operate the high pressure discharge projection lamp with an AC lamp current, characterized in that the lamp current has a frequency of at least 3 MHz.

2. Projection system according to claim 1, wherein the high pressure discharge projection lamp has an antenna.

3. Projection system according to claim 2, wherein the antenna is electrically connected with the first main electrode and extends along the discharge tube towards the second main electrode.

4. Projection system according to claim 1, wherein the distance between the first and second main electrode is smaller than or equal to 1.2 mm.

5. Projection system according to claim 4, wherein the distance between the first and the second main electrode is smaller than or equal to 1 mm.

6. Projection system according to claim 1, wherein the lamp current has a frequency in the range of 4 to 8 MHz.

7. A combination of a high pressure discharge projection lamp, having a discharge tube enclosing a discharge space and a first and second main electrode, with a ballast circuit to operate the high pressure discharge projection lamp with an ac lamp current, said combination being suitable for use in a projection system according to claim 1.

8. Ballast circuit suitable for use in a projection system according to claim 1.
